(19) United States
(12) Patent Application Publication
(10) Pub. No.: US 2019/0036339 A1
(43) Pub. Date: Jan. 31, 2019

(54) INTEGRATED DISTRIBUTION PLANNING SYSTEMS AND METHODS FOR ELECTRIC POWER SYSTEMS

(71) Applicant: Opus One Solutions Energy Corp., Richmond Hill (CA)

(72) Inventors: Joshua Wong, Toronto (CA); Ashkan Rahimi-Kian, Toronto (CA); Hisham Omara, Woodbridge (CA); Ken Chadha, Toronto (CA); Wajid Muneer, Toronto (CA)

(73) Assignee: Opus One Solutions Energy Corp., Richmond Hill (CA)

(21) Appl. No.: 15/990,502

(22) Filed: May 25, 2018

Related U.S. Application Data
(60) Provisional application No. 62/511,283, filed on May 25, 2017.

(51) Int. Cl. H02J 3/38; H02J 3/14

(52) U.S. Cl. CPC H02J 3/381; H02J 2003/007; H02J 3/14

(57) ABSTRACT

A multi-time frame distribution planning system which provides capacity planning and distributed energy resource planning is disclosed. In an embodiment, the system includes an interface for receiving electric power system input data for a plurality of data inputs including distributed energy resource data inputs and a data store including the electric power system input data. A computer processor coupled to the data store is programmed, upon receiving one or more commands, to use the electric power system input data to calculate at least one 3-phase AC power flow. The processor is further programmed to use the at least one 3-phase AC power flow to create at least one AC optimal power flow and use the AC optimal power flow to generate at least one potential scenario that includes distributed energy resources or hosting capacity for distributed energy resources.

This application claims priority to U.S. Provisional Patent Application No. 62/511,283 filed May 25, 2017, the entire disclosure of which is incorporated herein by reference.

This application includes material which is subject to copyright protection. The copyright owner has no objection to the facsimile reproduction by anyone of the patent disclosure, as it appears in the Patent and Trademark Office files or records, but otherwise reserves all copyright rights whatsoever.

### BACKGROUND

The increased penetration of Distributed Energy Resources (DERs) is occurring at the “edge” of grid distribution systems, resulting in a complex two-way power flow with impacts to power quality, grid capacity, protection, control, etc. in an aging and congested infrastructure. This poses a challenge to the applicability and optimality of today's distribution system planning systems and processes, including investment planning, reliability planning, capacity planning, contingency planning, asset utilization/health, maintenance schedules, coordination with distribution automation systems, and others.

This is especially the case since the distribution system is largely blind, lacking network wide visibility, controls, intelligence, and a means for understanding the value of DERs for value-based decision making.

Furthermore, as utilities begin to consider DERs and distribution automation (DA) technologies as a part of the infrastructure portfolio—and as electricity customers emerge as “prosumers” with DER capabilities—traditional utility planning faces challenges such as:
Traditional systems typically rely on top-down planning which is done in course intervals (e.g. once a year), and based on historical-worst case analysis. This provides planning that is highly conservative and ineffective for optimal utilization of assets, and results in a non-optimized investment portfolio.
DER planning is bottom-up, probabilistic and stochastic based, which challenges the long term stable nature of traditional system planning
Planning is typically run with a single time frame in mind (e.g. short term, medium term, long term), with minimal to no interactions between planning horizons
Planning is typically done on an ad hoc basis as an event, not as a continuous ongoing process, while grid operations, new loads and new DERs are continuous real time phenomenon
Limited (or negative) load growth on many distribution networks; diminished need/opportunity for capacity expansions
DERs are confounding conventional load forecast methodologies and complicating the modeling of distribution feeders by introducing new kinds of generation sources or modifying load profiles; weakened indicator for capacity planning of distribution assets (e.g., substations, transformers, breakers, switches, wires, and cables)
DERs and DA can provide cost-effective alternatives to traditional capacity planning within an operational timeframe (e.g., seconds, minutes, and day-ahead, rather than months to years). This requires the introduction of probabilistic and stochastic analyses to capacity planning (short term and long term)
Increased options for non-wires solutions (NWS) to traditional capacity expansion; DERs and DA technologies can provide loss minimization, peak-shaving/valley-filling, smart switching, and microgrid islanding
DER and DA impacts on asset utilization (and as a result, asset health and risk-based asset replacement programs).
Tools that are per user, desktop application based, rather than enterprise multi-user applications

Currently, the distribution system is typically assessed feeder by feeder, looking at load and most recently DER growth forecasted over the next five to ten years, and substations and feeders are planned where needed to meet system capacity, reliability and asset health. These assessments are mostly inadequate technical “work-arounds” such as a detailed analysis on select feeders and extrapolating results to others or a simplified screening analysis on all feeders. These solutions do not provide situational awareness, monetized value of DER assets or accurately account for the input uncertainty. Some solutions provide data rationalization and data visualization but lack a built-in power flow tool or any in-depth system analysis. Existing power flow tools typically run as a static tool for planning and operation processes and/or are heuristics or rules-based systems which are not sufficient in terms of flexibility, configurability, and reaching global optimality. For distribution systems with DER and DA penetration, only a 3-phase AC unbalanced model should be used. Any type of balanced and DC approximation that does not take into account the unbalanced nature of the grid, or that neglects the real and reactive components of grid behavior, will be insufficient.

Furthermore, existing planning methodologies predominately use worst-case-scenario interconnection studies to avoid the complexities of probabilistic and stochastic analyses. These one-time studies are insufficient to inform investment and asset utilization within distribution planning and lead to premature denial of DER interconnection to the grid.

### SUMMARY

In an embodiment, the presently disclosed Integrated Distribution Planning (IDP) system for Electric Power Systems (EPS) provides a multi-time frame holistic approach to distribution planning which includes both capacity planning—typically long-term, top-down, historical-worst-case based—and Distributed Energy Resource (DER) planning—typically bottom-up, ad-hoc and DER driven—while managing data uncertainty (e.g., Load forecast, DER forecast, DER type size and location, energy prices) to provide a transparent, quantitative, fact-based, granular, repeatable, and flexible planning tool that can be deployed in a gradual, modular and scalable fashion.

In an embodiment, the present invention combines distribution system state estimation (DSSE), scenario generation, prioritization process and stochastic security-constrained AC optimal power flow (SC-ACOPF) to:
Create an accurate 3-phase AC power flow and optimal power flow for situational awareness across the distribution network (including per phase voltages, currents, real power, reactive power, real loss, reactive losses, power factors, asset operation, asset utilization, load duration curves, and more), for the entire study period (e.g., 10 years, looking back as historical or looking forward as forecast) at each study interval (e.g., hourly), at every asset level, every phase and every node on the bus across the distribution network
Establish specific node, phase, feeder, and substation hosting capacity and capacity constraints for the entire study period (e.g., 10 years) at each study interval (e.g., hourly).
Quantify the technical performance of DER assets, as well as the locational net benefit analysis (LNBA) for value of DER evaluation, deriving values including distribution locational marginal pricing (DLMP) for monetized value of DER assets
Develop potential investment scenarios, hosting capacity upgrades, expansion strategies, and non-wires solutions (NWS), including traditional assets, DER assets, DER incentive programs, and DA assets (by location, asset, phase, capacity, and time), and analyze their technical and economic feasibility across the entire network.
Compute the marginal cost of providing electric power (both active and reactive) to meet the next n-year projected loads (active and reactive) for each planning year (per node/bus/zone) based on the marginal costs of distribution network assets (i.e. transformers, feeders, substations, etc.), levelized cost of energy (LCOE) for DER resources, and bulk power system LMP. The marginal cost of active power is called MC_P and that for reactive power is called MC_Q. These attributes are used for comparing different planning solutions (of a distribution network) in terms of financial investment and O&M costs.
Prioritize each expansion plan for the distribution network, using the mean-variance-portfolio (MVP) and/or conditional-value-at-risk (CVaR) method, to identify the risk-return trade-off curves for each expansion plan, derived for the system planner as a decision support system (DSS) tool
Incorporate asset health indices, failure rate, asset condition, age with SC-ACOPF to provide probabilistic and stochastic data-driven asset analytics, which feed into asset health, reliability and investment programs
Dynamically determine the hosting capacity on that node, phase, feeder, substation or region for each specific time interval
Determine day-ahead unit commitment for optimal DER dispatch for constraint management

In an embodiment, the disclosed system and method provides a continuous planning tool that dynamically adapts to changing network parameters, inputs and conditions. This key characteristic along with the present invention's multi-timeframe planning holistic approach makes the disclosed IDP system an operational, short term, medium and long term planning tool for utilities.

In an embodiment, the disclosed system and method provides a multi-user, enterprise planning tool that enables multiple users to plan off common share data sets and planning functionalities.

### BRIEF DESCRIPTION OF THE DRAWINGS

FIG. 1 shows a diagram illustrating inputs, functionality and outputs for each of four components of the invention in accordance with an embodiment thereof.

FIG. 2 shows a block diagram of a data processing system components of which can be used as the processor in various embodiments of the disclosed systems and methods.

FIG. 3 shows a block diagram of a user device.

### DETAILED DESCRIPTION

Reference will now be made in detail to the preferred embodiments of the present invention, examples of which are illustrated in the accompanying drawings. The following description and drawings are illustrative and are not to be construed as limiting. Numerous specific details are described to provide a thorough understanding. However, in certain instances, well-known or conventional details are not described in order to avoid obscuring the description. References to one or an embodiment in the present disclosure are not necessarily references to the same embodiment; and, such references mean at least one.

Reference in this specification to “an embodiment” or “the embodiment” means that a particular feature, structure, or characteristic described in connection with the embodiment is included in at least an embodiment of the disclosure. The appearances of the phrase “in an embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

The present invention is described below with reference to block diagrams and operational illustrations of methods and devices integrated electrical power distribution planning. It is understood that each block of the block diagrams or operational illustrations, and combinations of blocks in the block diagrams or operational illustrations, may be implemented by means of analog or digital hardware and computer program instructions. These computer program instructions may be stored on computer-readable media and provided to a processor of a general-purpose computer, special-purpose computer, ASIC, or other programmable data processing apparatus, such that the instructions, which execute via the processor of the computer or other programmable data processing apparatus, implements the functions/acts specified in the block diagrams or operational block or blocks. In some alternate implementations, the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved.

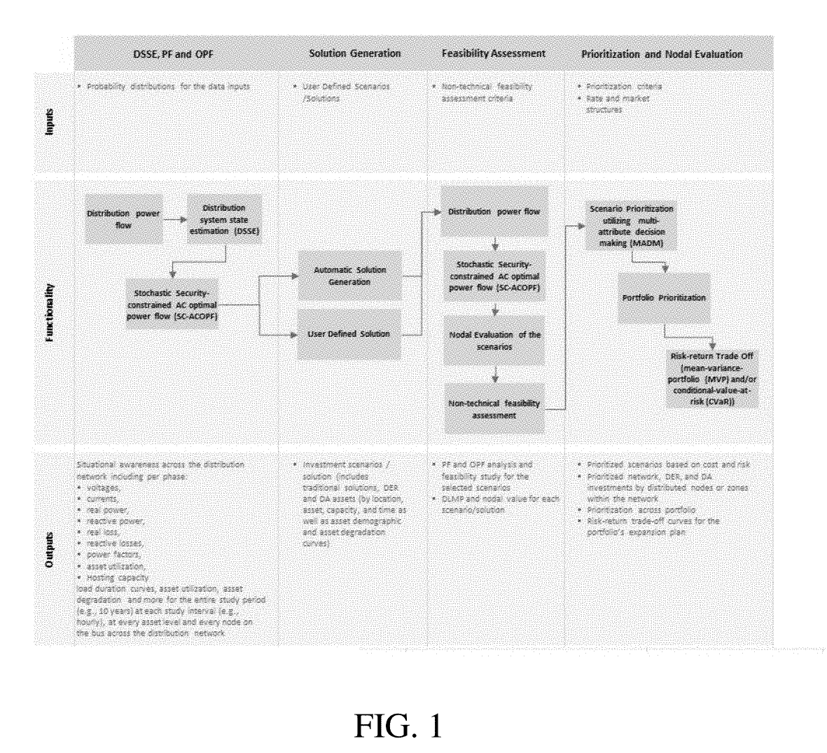

FIG. 1 shows a diagram illustrating inputs, functionality and outputs for each of four components of the invention in accordance with an embodiment thereof. These four components are distribution system state estimation (DSSE), scenario generation, Feasibility Assessment, and Prioritization and Nodal Evaluation. In an embodiment, the presently disclosed invention provides a set of systems, methodologies and process which combines capacity planning, asset level distribution planning and distribution energy resource planning while managing data uncertainty (e.g., Load forecast, DER forecast, DER size and location, energy prices) to provide a transparent, quantitative, fact-based, granular, repeatable, and flexible planning tool that can be deployed in a gradual, modular and scalable fashion.

In an embodiment, the presently disclosed system quantifies and evaluates potential scenarios (e.g., investment scenarios, hosting capacity upgrades, expansion strategies, and non-wires solutions) based asset benefits, by type, capacity, location, phase and time. Furthermore, the presently disclosed system can monetize the value of DER assets via distribution locational marginal pricing (DLMP), similar to bulk electric system level locational marginal pricing (LMP), and reveal the lowest cost and/or highest customer value options for DER and DA investment.

In an embodiment, the disclosed system and method provides a multi-user, enterprise planning tool that enables multiple users to plan off common share data sets and planning functionalities. In this respect, the invention may be configured as an enterprise application that uses a database to provide access to multiple users (e.g., multiple tenants) in an enterprise and wherein multiple users can utilize at least one common data set stored in the database.

In an embodiment, the presently disclosed system utilizes network connectivity based and geospatial representation techniques to statistically represent the key asset attributes (P, Q, V, I, hosting capacity, capacity constraints, DLMP and more at each node and asset). Using the system, planners are able to assess the network impacts using layers to:
Incorporate asset condition (age, condition, health index, asset condition assessment, maintenance inspection, within power flow analysis)
Play back historical power flow (P, Q, V, I, hosting capacity, capacity constraints) and DLMP parameters, as well as play forward on power flow and DLMP forecasts
Evaluate investment scenarios (utilizing a multi-attribute decision making, MADM prioritization engine)
Upload new investment scenarios
Establish specific node, feeder, and substation hosting capacity
Evaluate input uncertainty (Load forecast, DER forecasting, DER size and location, energy prices)

In an embodiment, the presently disclosed system provides the following key functionality:
Create accurate 3-phase AC optimal power flows for situational awareness across the distribution network, including per phase:
   voltages,
   currents,
   real power,
   reactive power,
   real loss,
   reactive losses,
   power factors,
   asset utilization,
   value of DER
   hosting capacity
   load duration curves, and more
      for the entire study period (e.g., 10 years) at each study interval (e.g., hourly), at every asset level and every node on the bus across the distribution network.
Establish specific node, feeder, and substation hosting capacity and capacity constraints for the entire study period (e.g., 10 years) at each study interval (e.g., hourly).
Quantify the technical performance of DER assets, as well as distribution locational marginal pricing (DLMP) for monetized value of DER assets
Develop potential investment scenarios, hosting capacity upgrades, expansion strategies, and non-wires solutions (NWS) including traditional assets, DER and DA assets (by location, phase, asset, capacity, and time), and analyze their economic and technical feasibility across the entire network
Prioritize each expansion plan based on customer defined criterium
Identify the risk-return trade-off for each expansion plan
Incorporate asset health indices, failure rate, asset condition, age with 3-phase AC optimal power flows to provide probabilistic and stochastic data-driven asset analytics, which feed into asset health, reliability and investment programs
Provide day-ahead unit commitment for optimal DER dispatch

Thus, as disclosed above and in the accompanying drawings, the presently disclosed system provides novel solutions and applications to address challenges facing utilities. In various embodiments, these include:
A system that combines capacity planning, asset level distribution planning and distribution energy resource planning while managing data uncertainty (e.g., Load forecast, DER forecast, DER size and location, energy prices) to provide a transparent, quantitative, fact-based, granular, repeatable, and flexible planning tool that can be deployed in a gradual, modular and scalable fashion
A system that utilizes 3-phase AC unbalanced model that accounts for the unbalanced nature of the grid and quantifies the real and reactive components of grid behavior
A system that creates accurate 3-phase AC optimal power flows for situational awareness across the distribution network including per phase for the entire study period (e.g., 10 years) at each study interval (e.g., hourly), at every asset level and every node on the bus across the distribution network
A system that utilizes a prioritization process with multi-attributes such as:
   asset/DER investment and O&M cost (including investment rate of return (IRR) and loan interest rate (LIR));
   system reliability indices (i.e. EENS, LOLP, SAIFI, SAIDI, CAIDI); system contingencies (i.e. high nodal voltage drops);
   feeder/transformer/branch congestions;
   high DLMP prices;
   plan's financial risk exposure (due to load/DER and energy/fuel price uncertainties and assumed probability distributions).
A system that produces a distribution improvement plan and investment portfolio to recommend the most cost-effective locations, asset investments and operating strategies to make grid-investments in anticipation of DER and load impact, by node, phase, feeder, and substation (locational), and by time of investment (temporal), with expected technical (e.g., MW, MVA) and economical metrics (e.g. based on DLMP)
A system that informs the setting of distribution rates, tariffs, and DER program design based on the locational and temporal value of DERs
A system that leverages probabilistic and stochastic capabilities to enable sophisticated analyses around uncertainties and portfolio risk management
A system that provides a multi-user, enterprise planning tool that enables multiple users to plan off common share data sets and planning functionalities

The presently disclosed system for integrated planning and distribution can be expanded to include the integration of distribution, transmission and generation planning. This can facilitate the harmonizing of planning and operational planning across the energy value chain, and also allow for distribution assets to be used for transmission and generation priorities.

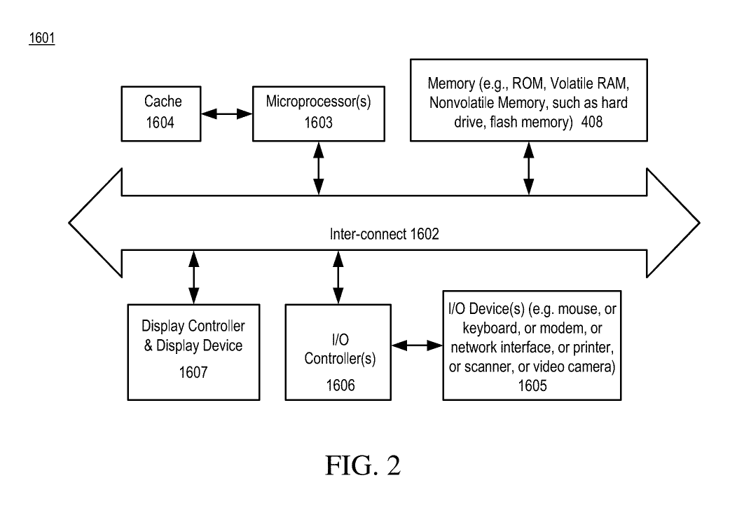

FIG. 2 shows a block diagram of a data processing system components of which can be used as the processor in various embodiments of the disclosed systems and methods. While FIG. 2 illustrates various components of a computer system, it is not intended to represent any particular architecture or manner of interconnecting the components. Other systems that have fewer or more components may also be used.

In FIG. 2, the system 1601 includes an inter-connect 1602 (e.g., bus and system core logic), which interconnects a microprocessor(s) 1603 and memory 1608. The microprocessor 1603 is coupled to cache memory 1604 in the example of FIG. 2.

The inter-connect 1602 interconnects the microprocessor(s) 1603 and the memory 1608 together and also interconnects them to a display controller and display device 1607 and to peripheral devices such as input/output (I/O) devices 1605 through an input/output controller(s) 1606. Typical I/O devices include mice, keyboards, modems, network interfaces, printers, scanners, video cameras and other devices that are well known in the art.

The inter-connect 1602 may include one or more buses connected to one another through various bridges, controllers and/or adapters. In one embodiment the I/O controller 1606 includes a USB (Universal Serial Bus) adapter for controlling USB peripherals, and/or an IEEE-1394 bus adapter for controlling IEEE-1394 peripherals.

The memory 1608 may include ROM (Read-Only Memory) and volatile RAM (Random Access Memory), and non-volatile memory, such as hard drive, flash memory, etc. Volatile RAM is typically implemented as dynamic RAM (DRAM) that requires power continually in order to refresh or maintain the data in the memory. Non-volatile memory is typically a magnetic hard drive, a magnetic optical drive, or an optical drive (e.g., a DVD RAM), or other type of memory system which maintains data even after power is removed from the system. The non-volatile memory may also be a random access memory. The non-volatile memory can be a local device coupled directly to the rest of the components in the data processing system. A non-volatile memory that is remote from the system, such as a network storage device coupled to the data processing system through a network interface such as a modem or Ethernet interface, can also be used.

In an embodiment, one or more servers supporting the platform are implemented using one or more data processing systems as illustrated in FIG. 2. In an embodiment, user devices such as those used to access the user interfaces described above are implemented using one or more data processing system as illustrated in FIG. 2.

In some embodiments, one or more servers of the system illustrated in FIG. 2 are replaced with the service of a peer-to-peer network or a cloud configuration of a plurality of data processing systems, or a network of distributed computing systems. The peer-to-peer network, or cloud-based server system, can be collectively viewed as a server data processing system.

Embodiments of the system disclosed above can be implemented via the microprocessor(s) 1603 and/or the memory 1608. For example, the functionalities described above can be partially implemented via hardware logic in the microprocessor(s) 1603 and partially using the instructions stored in the memory 1608. Some embodiments are implemented using the microprocessor(s) 1603 without additional instructions stored in the memory 1608. Some embodiments are implemented using the instructions stored in the memory 1608 for execution by one or more general-purpose microprocessor(s) 1603. Thus, the disclosure is not limited to a specific configuration of hardware and/or software.

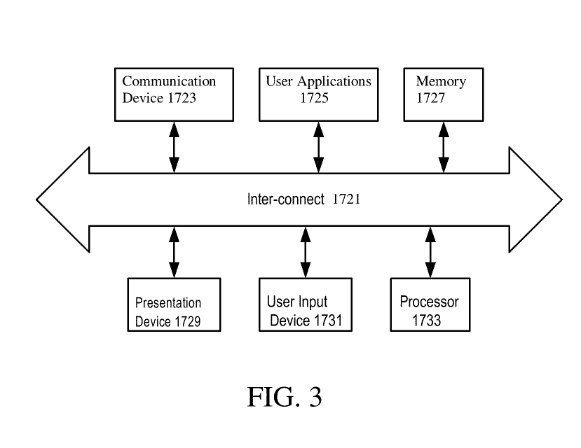

FIG. 3 shows a block diagram of a user device. In FIG. 3, the user device includes an inter-connect 1721 connecting a communication device 1723, such as a network interface device, a presentation device 1729, such as a display screen, a user input device 1731, such as a keyboard or touch screen, user applications 1725 implemented as hardware, software, firmware or a combination of any of such media, such various user applications (e.g. apps), a memory 1727, such as RAM or magnetic storage, and a processor 1733 that, inter alia, executes the user applications 1725.

In one embodiment, the user applications implement one or more user interfaces displayed on the presentation device 1729 that provides users and the system the capabilities to, for example, access a Wide Area Network (WAN) such as the Internet, and display and interact with user interfaces provided by the platform, such as, for example the user interfaces described above in this disclosure. In an embodiment, users use the user input device 1731 to interact with the device via the user applications 1725 supported by the device.

While some embodiments can be implemented in fully functioning computers and computer systems, various embodiments are capable of being distributed as a computing product in a variety of forms and are capable of being applied regardless of the particular type of machine or computer-readable media used to actually effect the distribution.

At least some aspects disclosed above can be embodied, at least in part, in software. That is, the techniques may be carried out in a special purpose or general purpose computer system or other data processing system in response to its processor, such as a microprocessor, executing sequences of instructions contained in a memory, such as ROM, volatile RAM, non-volatile memory, cache or a remote storage device. Functions expressed herein may be performed by a processor in combination with memory storing code and should not be interpreted as means-plus-function limitations.

Routines executed to implement the embodiments may be implemented as part of an operating system, firmware, ROM, middleware, service delivery platform, SDK (Software Development Kit) component, web services, or other specific application, component, program, object, module or sequence of instructions referred to as “computer programs.” Invocation interfaces to these routines can be exposed to a software development community as an API (Application Programming Interface). The computer programs typically comprise one or more instructions set at various times in various memory and storage devices in a computer, and that, when read and executed by one or more processors in a computer, cause the computer to perform operations necessary to execute elements involving the various aspects.

A machine-readable medium can be used to store software and data which when executed by a data processing system causes the system to perform various methods. The executable software and data may be stored in various places including for example ROM, volatile RAM, non-volatile memory and/or cache. Portions of this software and/or data may be stored in any one of these storage devices. Further, the data and instructions can be obtained from centralized servers or peer-to-peer networks. Different portions of the data and instructions can be obtained from different centralized servers and/or peer-to-peer networks at different times and in different communication sessions or in a same communication session. The data and instructions can be obtained in entirety prior to the execution of the applications. Alternatively, portions of the data and instructions can be obtained dynamically, just in time, when needed for execution. Thus, it is not required that the data and instructions be on a machine-readable medium in entirety at a particular instance of time.

Examples of computer-readable media include but are not limited to recordable and non-recordable type media such as volatile and non-volatile memory devices, read only memory (ROM), random access memory (RAM), flash memory devices, floppy and other removable disks, magnetic disk storage media, optical storage media (e.g., Compact Disk Read-Only Memory (CD ROMS), Digital Versatile Disks (DVDs), etc.), among others.

In general, a machine-readable medium includes any mechanism that provides (e.g., stores) information in a form accessible by a machine (e.g., a computer, network device, personal digital assistant, manufacturing tool, any device with a set of one or more processors, etc.).

In various embodiments, hardwired circuitry may be used in combination with software instructions to implement the techniques disclosed above. Thus, the techniques are neither limited to any specific combination of hardware circuitry and software nor to any particular source for the instructions executed by the data processing system.

The above embodiments and preferences are illustrative of the present invention. It is neither necessary, nor intended for this patent to outline or define every possible combination or embodiment. The inventor has disclosed sufficient information to permit one skilled in the art to practice at least one embodiment of the invention. The above description and drawings are merely illustrative of the present invention and that changes in components, structure and procedure are possible without departing from the scope of the present invention. For example, elements and/or steps described herein in a particular order may be practiced in a different order without departing from the invention. Thus, while the invention has been particularly shown and described with reference to embodiments thereof, it will be understood by those skilled in the art that various changes in form and details may be made therein without departing from the spirit and scope of the invention.

What is claimed is:

1. A multi-time frame distribution planning system which provides capacity planning and distributed energy resource planning, comprising:
interface for receiving electric power system input data for a plurality of data inputs including distributed energy resource data inputs;
a data store including said electric power system input data; and
a computer processor coupled to the data store and programmed, upon receiving one or more commands, to:
i) use the electric power system input data to calculate at least one 3-phase AC power flow;
ii) use the at least one 3-phase AC power flow to create at least one AC optimal power flow;
iii) use the AC optimal power flow to generate at least one potential scenario that includes distributed energy resources or hosting capacity for distributed energy resources.

2. The multi-time frame distribution planning system according to claim 1, wherein the processor is further programmed to utilize the electric power system input data to create at least one distribution system state estimation.

3. The multi-time frame distribution planning system according to claim 1, wherein said AC optimal power flow comprises a probabilistic stochastic security-constrained AC power flow optimization function.

4. The multi-time frame distribution planning system according to claim 1, wherein the processor is further programmed to utilize multiple time frames to generate a long-term scenario.

5. The multi-time frame distribution planning system according to claim 1, wherein the potential scenario comprises an investment scenario, asset health and condition management plan, hosting capacity upgrade, DER value optimization plan, DER dispatch strategy, reliability improvement plan, expansion strategy, or non-wires solution.

6. The multi-time frame distribution planning system according to claim 1, wherein the potential scenario comprises a scenario over a short-term time frame of seconds, minutes, hours, or day-ahead.

7. The multi-time frame distribution planning system according to claim 1, wherein the potential scenario comprises a scenario that includes distributed energy resource and distributed automation assets by location, phase, asset, capacity and time.

8. The multi-time frame distribution planning system according to claim 1, wherein the processor is further programmed to use at least one potential scenario to create a feasibility assessment.

9. The multi-time frame distribution planning system according to claim 8, wherein said creation of said feasibility assessment comprises using the at least one potential scenario to generate a distribution power flow.

10. The multi-time frame distribution planning system according to claim 9, wherein said creation of said feasibility assessment comprises using the distribution power flow to create an AC optimal power flow.

11. The multi-time frame distribution planning system according to claim 1, wherein the processor is further programmed to use the feasibility assessment to generate a scenario prioritization of said potential scenario and at least one additional potential scenario.

12. The multi-time frame distribution planning system according to claim 11, wherein said scenario prioritization comprises a prioritization using multi-attribute decision-making.

13. The multi-time frame distribution planning system according to claim 1, wherein the processor is further programmed to use the scenario prioritization to generate a second distribution power flow.

14. The multi-time frame distribution planning system according to claim 13, wherein the wherein the processor is further programmed to use the second distribution power flow to generate a second AC optimal power flow.

15. The multi-time frame distribution planning system according to claim 14, wherein the processor is further programmed to use the second AC optimal power flow to create a nodal evaluation of said potential scenario.

16. The multi-time frame distribution planning system according to claim 15, wherein the processor is further programmed to use said nodal evaluation to generate at least one additional nodal evaluation.

17. The multi-time frame distribution planning system according to claim 1, wherein multiple users can simultaneously access common data sets and share planning functionalities.

18. The multi-time frame distribution planning system according to claim 1, wherein the processor is further programmed to calculate locational and temporal values of distributed energy resources so as to inform setting of distribution rates, tariffs, and DER program design.

19. The multi-time frame distribution planning system according to claim 1, wherein the at least one potential scenario comprises an investment scenario.

20. The multi-time frame distribution planning system according to claim 1, wherein the at least one potential scenario comprises at least one of: a solution, distributed energy resource assets, and distributed automation assets.

21. The multi-time frame distribution planning system according to claim 1, wherein the data store comprises a database and the processor is further programmed to access the database to provide a multi-user enterprise planning tool that enables multiple users to plan off common share data sets and planning functionalities

22. A distribution planning system which provides capacity planning and distributed energy resource planning, comprising:
interface for receiving electric power system input data for a plurality of data inputs including distributed energy resource data inputs;
a data store including said electric power system input data; and
a computer processor coupled to the data store and programmed, upon receiving one or more commands, to:
i) use the electric power system input data to create at least one distribution system state estimation;
ii) use the distribution system state estimation to create at least one 3-phase AC power flow;
iii) use the 3-phase AC power flow to create at least one AC optimal power flow;
iv) use the at least one AC optimal power flow to generate at least one potential scenario that includes distributed energy resources or hosting capacity for distributed energy resources.

23. The distribution planning system according to claim 22, wherein the processor is further programmed to use the at least one AC optimal power flow to derive at least one hosting capacity.

24. The distribution planning system according to claim 23, wherein the processor is further programmed to derive the at least one hosting capacity on a specified node, phase, feeder, substation or region for each specific hour time interval among a plurality of time intervals.

25. The distribution planning system according to claim 22, wherein the processor is further programmed to use the at least one AC optimal power flow to derive at least one value of distributed energy resource results.
